(19) United States
(12) Patent Application Publication
(10) Pub. No.: US 2003/0174146 A1
(43) Pub. Date: Sep. 18, 2003

(54) Apparatus and method for providing electronic image manipulation in video conferencing applications

(76) Inventor: Michael Kenoyer, Austin, TX (US)

Correspondence Address: WONG, CABELLO, LUTSCH, RUTHERFORD & BRUCCULERI,, P.C., 20333 SH 249, SUITE 600, HOUSTON, TX, 77070, US

(21) Appl. No.: 10/358,758

(22) Filed: Feb. 4, 2003

Related U.S. Application Data
(60) Provisional application No. 60/354,587, filed on Feb. 4, 2002.

(51) Int. Cl. G09G 5/00

(52) U.S. Cl. 345/619; 345/581

(57) ABSTRACT

The present invention is an apparatus and method for processing and manipulating one or more video images for use in a video conference. An exemplary embodiment of the present invention is a video conference endpoint including an image sensor to generate an image, and a controller configured to translate a portion of the image by one or more pixels in response to a translation control signal. The controller is configured to increase a number of a pixel cells associated with the portion of the image in response to a zoom-out control signal, and to decrease the number of the pixel cells associated with the portion of the image in response to a zoom-in control signal.

### CROSS-REFERENCE TO RELATED APPLICATION

This application claims priority and benefit of U.S. Provisional Patent Application Serial No. 60/354, 587 entitled, “APPARATUS AND METHOD FOR PROVIDING ELECTRONIC IMAGE MANIPULATION IN VIDEO CONFERENCING APPLICATIONS,” and filed on Feb. 4, 2002, which is hereby incorporated by reference.

### BACKGROUND OF THE INVENTION

1.Field of the Invention

The present invention relates to image processing and communication thereof, and in particular, to an apparatus and method for processing and manipulating one or more video images for use in a video conference.

2.Description of Related Art

The use of audio and video conferencing devices has increased dramatically in recent years. Such devices (collectively denoted herein as “conference endpoints”) facilitate communication between persons or groups of persons situated remotely from each other, and allow companies having geographically dispersed business operations to conduct meetings of persons or groups situated at different offices, thereby obviating the need for expensive and time-consuming business travel.

FIG. 1 illustrates a convention conference endpoint 100. The endpoint 100 includes a camera lens system 102 rotatably connected to a camera base 104 for receiving audio and video of a scene of interest, such as the environs adjacent table 114 as well as conference participants themselves. The camera lens system 102 is typically connected to the camera base 104 in a manner such that the camera lens system 102 is able to move in response to one or more control signals. By moving the camera lens system 102, the view of the scene presented to remote conference participants changes according to the control signals. In particular, the camera lens system 102 may pan, tilt and zoom in and out, and therefore, is generally referred to as a pan-tilt-zoom (“PTZ”) camera. “Pan” refers to a horizontal camera movement along an axis (i.e., the X-axis) either from right to left or left to right. “Tilt” refers to a vertical camera movement along an axis either up or down (i.e., the Y-axis). “Zoom” controls the viewing depth or field of view (i.e., the Z-axis) of a video image by varying lens focal length to an object.

In this illustration, audio communications are also received and transmitted via line 110 by a video conference microphone 112. One or more video images of the geographically remote conference participants are displayed on a display 108 operating on a display monitor 106. The display monitor 106 can be a television, computer, stand-alone display (e.g., a liquid crystal display, “LCD”), or the like and can be configured to receive user inputs to manipulate images displayed on the display 108.

FIG. 2 depicts a traditional PTZ camera 200 used in conventional video teleconference applications. The PTZ camera 200 includes a lens system 202 and base 204. The lens system 202 consists of a lens mechanism 222 under the control of a lens motor 226. The lens mechanism 222 can be any transparent optical component that consists of one or more pieces of optical glass. The surfaces of the optical glass are usually curved in shape and function to converge or diverge light emanating from an object 220, thus forming a real or virtual image of the object 220 for image capture.

Light associated with the real image of the object 220 is optically projected onto an image array 224 of a charge coupled devices (“CCD”), which acts as an image plane. The image array 224 takes the scene information and partitions the image into discrete elements (e.g., pixels) where the scene and object are defined by a number of elements. The image array 224 is coupled to an image signal processor 230 and provides electronic signals to the image signal processor 230. The signals, for example, are voltages representing color values associated with each individual pixel and may correspond to analog values or digitized values (digitized by an analog-to-digital converter).

The lens motor 226 is coupled to the lens mechanism 222 to mechanically change the field of view by “zooming in” and “zooming out.” The lens motor 226 performs the zoom function under the control of a lens controller 228. The lens motor 226 and other motors associated with the camera 200 (i.e., tilt motor and drive 232 and pan motor and drive 234) are electromechanical devices that use electrical power to mechanically manipulate the image viewed by, for example, geographically remote participants. The tilt motor and drive 232 is included in the lens system 202 and provides for a mechanical means to vertically move the image viewed by the remote participants.

The base 204 includes a controller 236 for controlling image manipulation by not only using the electromechanical devices, but also by changing color, brightness, sharpness, etc. of the image. An example of the controller 236 can be a central processing unit (CPU) or the like. The controller 236 is also connected to the pan motor and drive 234 to control the mechanical means for horizontally moving the image viewed by the remote participants. The controller 236 communicates with the remote participants to receive control signals to, for example, control the panning, tilting, and zooming aspects of the camera 200. The controller 236 also manages and provides for the communication of video signals representing the image of the object 220 to the remote participants. A power supply 238 provides the camera 200 and its components with electrical power to operate the camera 200.

There exist many drawbacks inherent in conventional cameras used in traditional teleconference applications, including the camera 200. Electro-mechanical panning, tilting, and zooming devices add significant costs to the manufacture of the camera 200. Furthermore, these devices also decrease the overall reliability of the camera 200. Since each element has its own failure rate, the overall reliability of the camera 200 is detrimentally impacted with each added electromechanical device. This is primarily because mechanical devices are more prone to motion-induced failure than non-moving electronic equivalents.

Furthermore, switching between preset views associated with predetermined zoom and size settings for capturing and displaying images take a certain interval of time to adjust. This is primarily due to lag time associated with mechanical device adjustments made to accommodate switching between preset views. For example, a maximum zoom out may be preset on power-up of a data conference system. A next preset button, when depressed, can include a predetermined “pan right” at “normal zoom” function. In a conventional camera, the mechanical devices associated with changing the horizontal camera and zoom lens positions take time to adjust according to the new preset level, thus inconveniencing the remote participants.

Another drawback to conventional cameras used in video conferencing application is that the camera is designed primarily to provide one view to a remote participant. For example, if the display of three views is desired at a remote participant site, then three independently operable cameras thus would be required. Therefore, there is a need in the art to overcome the aforementioned drawbacks associated with the conventional cameras and teleconferencing techniques.

### SUMMARY OF THE INVENTION

In accordance with an exemplary embodiment of the present invention, an apparatus allows a remote participant in a video conference to manipulate image data processed by the apparatus to effect pan, tilt, and zoom functions without the use of electromechanical devices or without requiring additional image data capture. Moreover, the present invention provides for generation of multiple views of a scene wherein each of the multiple views are based upon the same image data captured at an imager.

According to another embodiment of the present invention, an exemplary system is provided for processing and manipulating image data, where the system is an imaging circuit integrated into a semiconductor chip. The imaging circuit is designed to provide electronic pan, tilt, and zoom capabilities as well as multiple views of moving objects in a scene. Since the imaging circuit and its array are capable of generating images of high resolution, the imaging data generated according to the present invention is suitable for presentation or display in 16×9 format, high definition television (“HDTV”) format, or other similar video formats. Advantageously, the exemplary imaging circuit provides for 12× or more zoom capabilities with more than 70-75 degrees field of view.

In accordance to an embodiment of the present invention, an imaging device with minimal or no moving parts allows instantaneous or near-instantaneous response to presenting multiple views according to preset pan, tilt, and zoom characteristics.

### BRIEF DESCRIPTION OF THE DRAWINGS

FIG. 1 illustrates a conventional video conferencing platform using a camera;

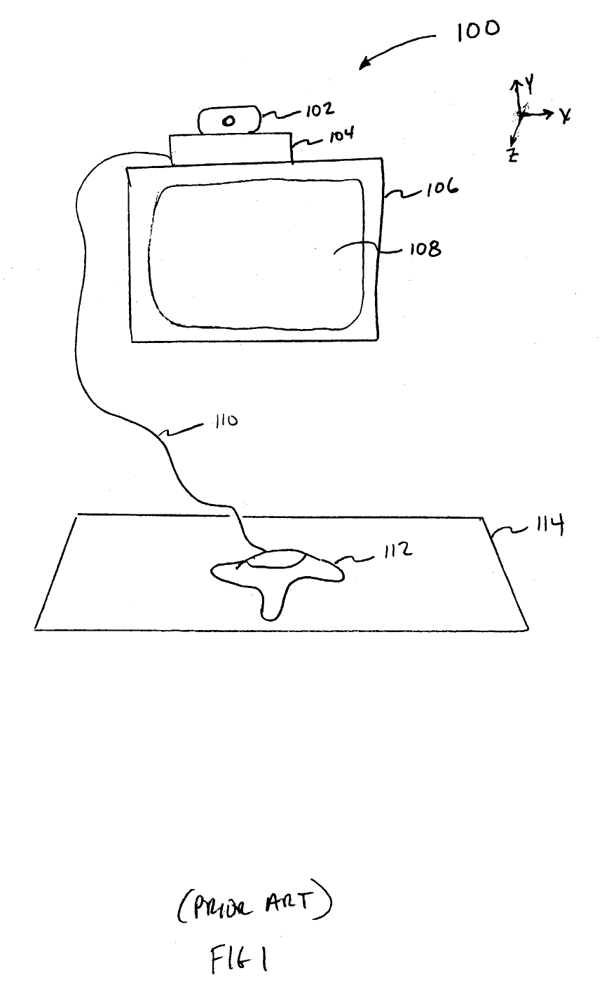

FIG. 2 is a functional block diagram of a basic operating system of a traditional camera used in video conferencing;

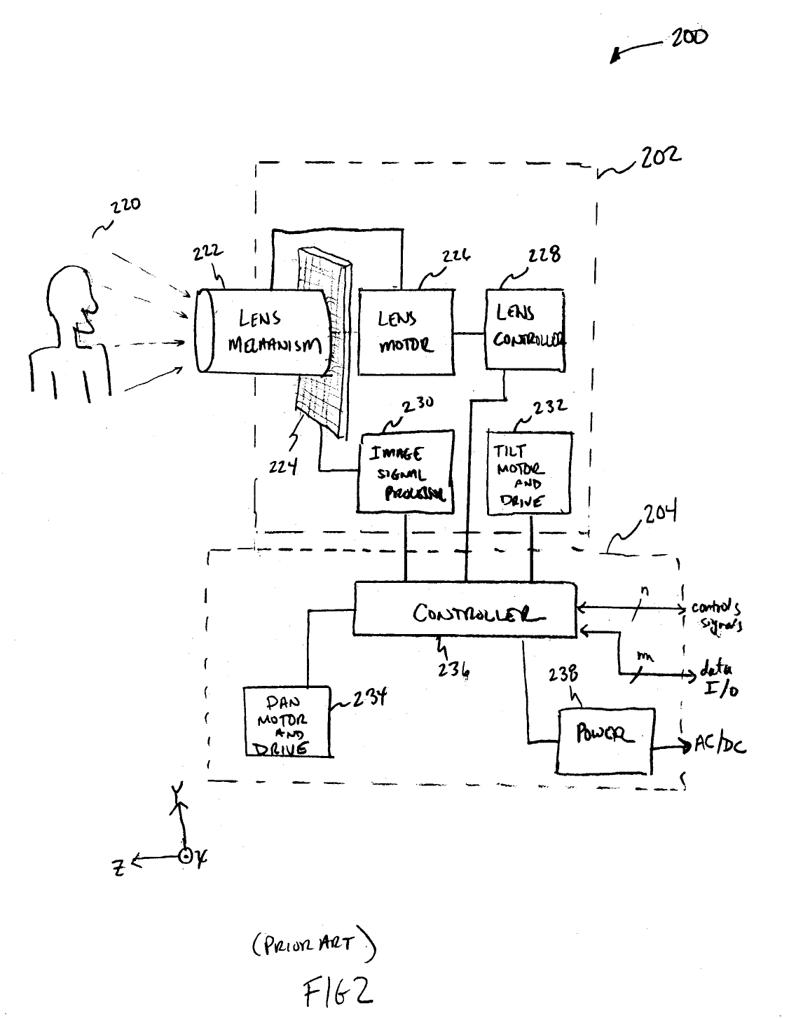

FIG. 3 is a functional block diagram of a basic imaging system in accordance with an exemplary embodiment of the present invention;

FIG. 4A depicts an exemplary display pixel formed by one or more pixel cells according to an embodiment of the present invention;

FIG. 4B depicts an exemplary display pixel of a pan operation according to an embodiment of the present invention;

FIG. 4C depicts an exemplary display pixel of a tilt operation according to an embodiment of the present invention;

FIG. 4D depicts an exemplary display pixel of a zoom-in operation according to an embodiment of the present invention;

FIG. 5A is a functional block diagram of the imaging system in accordance with another exemplary embodiment of the present invention;

FIG. 5B is a functional block diagram of the imaging system controller in accordance with an exemplary embodiment of the present invention;

FIG. 6 illustrates how a captured image may be manipulated for display at a remote display associated with a remote conference endpoint;

FIG. 7 illustrates three exemplary view windows defining specific image data to be used to generate corresponding views; and

FIG. 8 depicts a display of the three views presented of FIG. 7 to remote participants according to an exemplary embodiment of the present invention.

### DESCRIPTION OF EXEMPLARY EMBODIMENTS

Detailed descriptions of exemplary embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure, method, process, or manner.

The present invention provides an imaging device and method for capturing an image of a local scene, processing the image, and manipulating one or more video images during a data conference between a local participant and a remote participant. The local participant is also referred herein to as an object of the scene imaged. The present invention also provides for communicating one or more images to the remote participant. The remote participant is located at a different geographic location than the local participant and has at least a receiving means to view the images captured by the imaging device.

In accordance to a specific embodiment of the present invention, an exemplary imaging device is a camera that is designed to produce one or more views of an object and its surrounding environment (i.e., scene) from each frame optically generated by an imager element of the camera. Each of the multiple views is provided to remote participants for display, where the remote participants have the ability to control the visual aspects of each view, such as zoom, pan, tilt, etc. In accordance with the present invention, each of the multiple views displayed at a remote participants' receiving device (e.g., remote participant's data conferencing device), need only be generated from one frame of information captured by the imager of the imaging device.

A frame contains spatial information used to define an image at a specific time, t, where such information includes a select number of pixels. A next frame also contains spatial information at another specific time, t+1, where the difference in information is indicative of motion detected within the scene. The frame rate is the rate at which frames and the associated spatial information are captured by an imager over time interval At, such as between t and t+1.

The spatial information includes one or more pixels where a pixel is any one of a number of small, discrete picture elements that together constitute an image. A pixel also refers to any of the detecting elements (i.e., pixel cell) of an imaging device, such as a CCD or CMOS imager, used as an optical sensor.

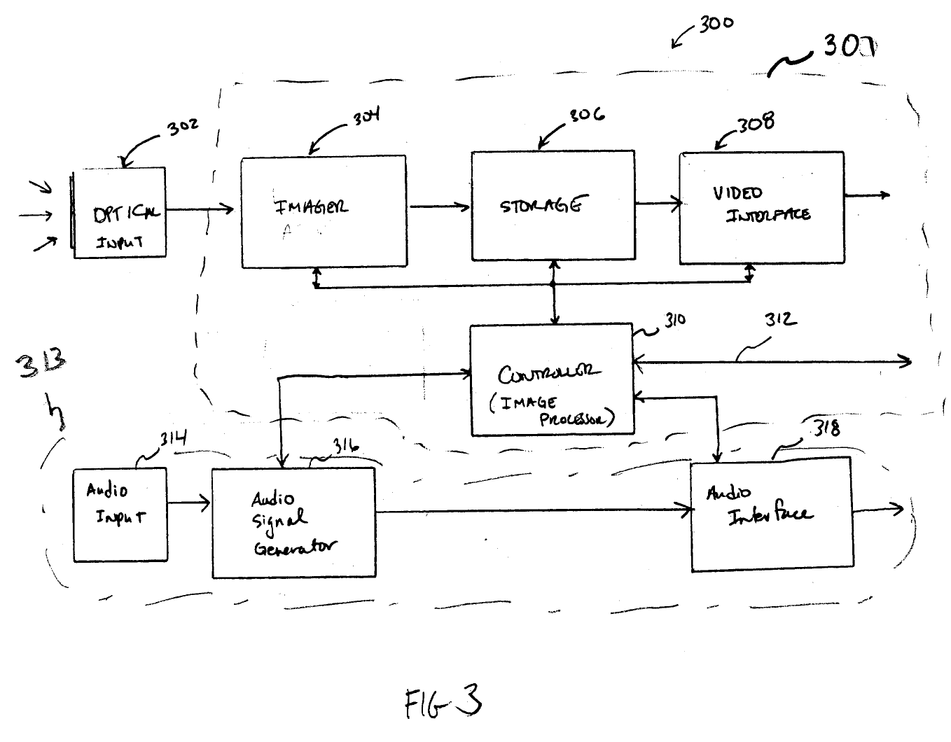

FIG. 3 is a simplified functional block diagram 300 illustrating relevant aspects in an exemplary camera. The exemplary camera 300 comprises an image system 301 and an optional audio system 313. In accordance to a specific embodiment of the present invention, the image system 301 provides for capturing, processing, manipulating, and transmitting images. In one exemplary embodiment, the image system 301 is a circuit configured to receive optical representations of an image in an imager 304 and also includes a controller 310 coupled to the imager 304, data storage 306, and a video interface 308. In general, the controller 310 is designed to control capture at the imager 304 of one or more frames, where the one or more frames contain data representing a scene. The controller 310 also processes the captured image data to generate, for example, multiple views of the scene. Furthermore, the controller 310 manages the transmission of data representing multiple views from the image system 301 via the video interface 308 to remote participants.

An optical input 302 is designed to provide an optically focused image to the imager 304. The optical input 302 is preferably a lens of any transparent optical component that includes one or more pieces of optical material, such as glass. In one example, the lens may provide for optimal focusing of light onto the imager 304 without a mechanical zoom mechanism, thus effectuating a digital zoom. In another example, however, the optical input 302 can include a mechanical zoom mechanism, as is well-known in the art, to enhance the digital zoom capabilities of the camera 300.

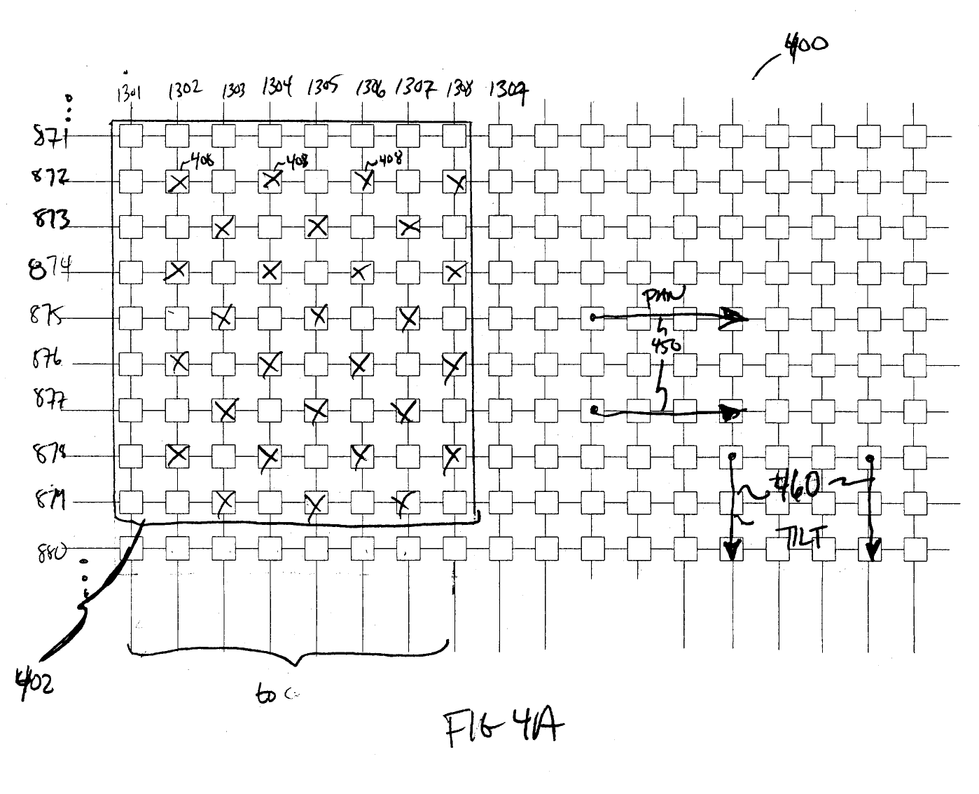

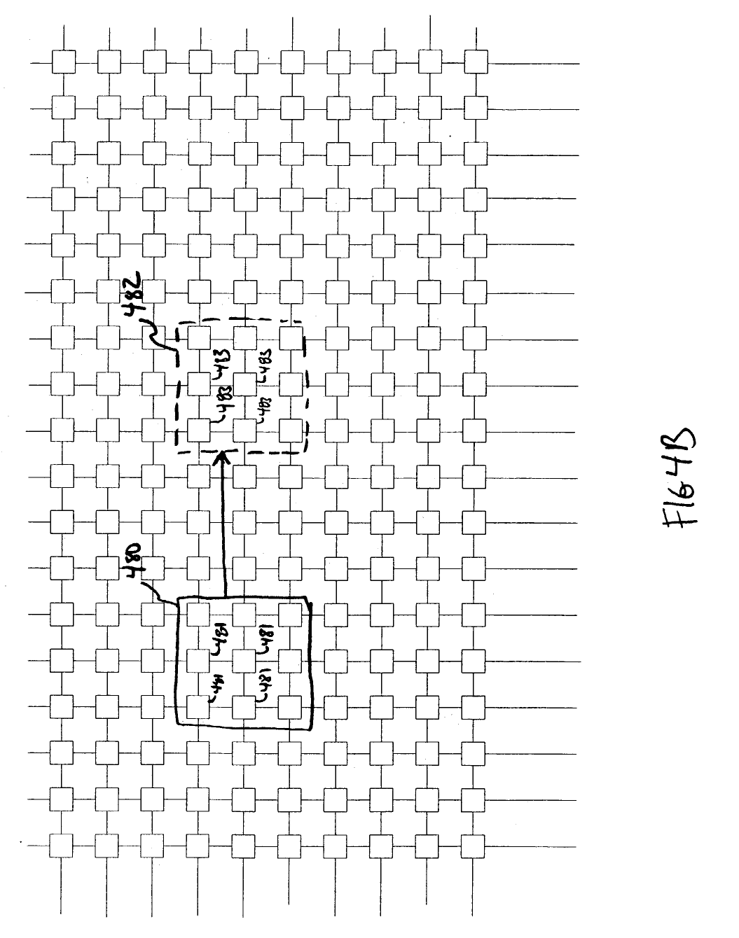

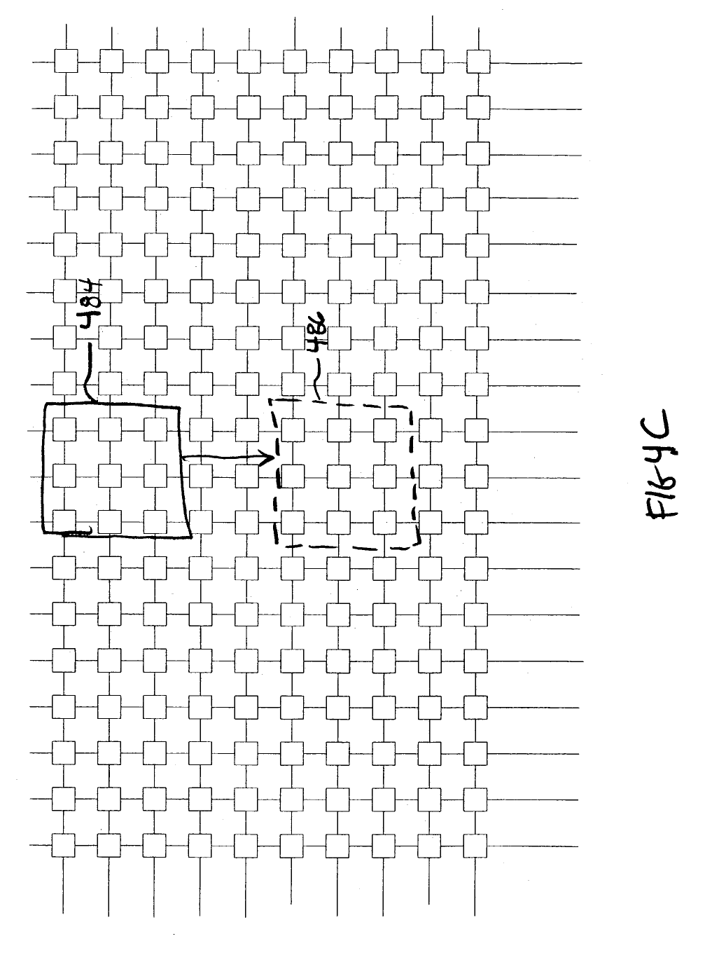

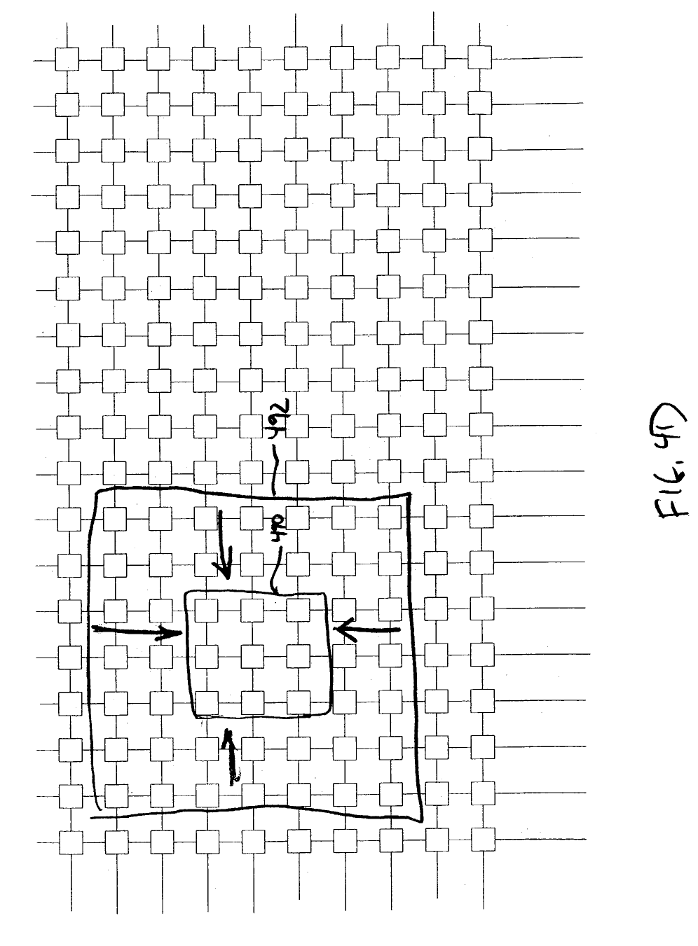

In one embodiment, the exemplary imager 304 is a CMOS (Complementary Metal Oxide Semiconductor) imaging sensor. CMOS imaging sensors detect and convert incident light (i.e., photons) by first converting light into electronic charge (i.e., electrons) and then converting the charge into digital bits. The CMOS imaging sensor is typically an array of photodiodes configured to detect visible light and, optionally, may contain micro-lens and color filters adapted for each photodiode making up an array. Such CMOS imaging sensors operate similarly as charge coupled devices (CCD). Although the CMOS imaging sensor is described herein to include photodiodes, the use of other similar semiconductor structures and devices are within the scope of the present invention. As will be discussed below, FIG. 4 illustrates a portion of a sensor array and control circuitry according to an embodiment of the present invention. Furthermore, alternative imaging sensors (i.e., non-CMOS) may be utilized in the present invention.

An exemplary CMOS pixel array can be based on active or passive pixels, or other CMOS pixel-types known in the art, either of which represent the smallest picture element of an image captured by the CMOS pixel array. A passive pixel is a simpler internal structure than the active pixel and does not amplify the photodiode's charge associated with each pixel. In contrast, active-pixel sensors (APS) include an amplifier to amplify the charge associated with pixel information (e.g., related to color).

Referring back to FIG. 3, the imager 304 includes additional circuitry to convert the charge associated with each of the pixels to a digital signal. That is, each pixel is associated with at least one CMOS transistor for selecting, amplifying, and transferring the signals from each pixel's photodiode. For example, the additional circuitry can include a timing generator, a row selector, and a column selector circuitry to select a charge from one or more specific photodiodes. The additional circuitry can also include amplifiers, analog-to-digital converts (e.g., 12-bit A/D converter), multiplexers, etc. Moreover, the additional circuit is, generally, physically disposed around or adjacent to a sensor array and includes circuits for dynamically amplifying the signal depending on lighting conditions, suppressing random and spatial noise, digitizing the video signal, translating the digital video stream into an optimum format, and other imaging circuitry for performing similar imaging functions.

A suitable imaging circuit to realize the imager 304 is an integrated circuit similar to the ProCam-1™ CMOS Imaging Sensor of Rockwell Scientific Company, LLC. Although such a sensor may provide a total number of 2008 by 1094 pixels, a sensor providing any number of pixels is within the scope of the present invention.

The storage 306 in an exemplary embodiment of the present invention is coupled to the imager 304 to receive and store pixel data associated with each pixel of the array of the imager 304. The storage 306 can be RAM, Flash memory, a floppy drive, or any other memory device known in the art. In operation, the exemplary storage 306 stores frame information from a prior point in time. In another embodiment, the storage 306 includes data differentiator (e.g., motion matching) circuitry to determine whether one or more pixel changes over time At between frames. If a specific pixel or data representing pixel information has the same information over At, then the pixel information need not be transmitted, thus saving bandwidth and ensuring optimal transmission rates. In yet another embodiment, the storage 306 is absent from the imaging system 301 circuit and digitized pixel data from the imager 304 are communicated directly to the video interface 308. In such an embodiment, processing of the image is performed at the remote participant's computing device.

The video interface 308 is designed to receive image data from the storage 306, format the image data into a suitable video signal, and communicate the video signal to remote participants. The communication medium between the local and remote participants can be a LAN, WAN, the Internet, POTS or other copper-wire base telephone line, wireless network, or any like communication medium known in the art.

The controller 310 operates responsive to control signals 312 from one or more remote participants. The controller 310 functions to determine which pixels are required to present one or more views to the remote participants as defined by the remote participants. For example, if the remote participants desire three views of the scene associated with the local participants, then each of the remote participants can independently select and specify whether any of the controlled views are to be zoomed in or out, panned right or left, tilted up or down, etc. The views controlled by the participants can be based upon an individual frame containing all pixels or a sub-set thereof.

In yet another embodiment, the image system 301 may be designed to operate with the audio system 313 for capturing, processing, and transmitting aural communications associated with the visual images. In this embodiment, the controller 310 generates, for example, digitized representations of sounds captured at an audio input 314. An exemplary audio signal generator 316 can be, for example, an analog-todigital converter designed to sufficiently convert analog sound signals into digitized representations of the captured sounds. The controller 310 also is configured to adapt (i.e., format) the digitized sounds for transmission via an audio interface 318. Alternatively, the aural communications may be transmitted to a remote destination by the same means as the video signal. That is, both the image and sounds captured by the systems 301 and 313, respectively, are transmitted to remote users via the same communication channel. In still yet another embodiment, the systems 301 and 313 as well as their elements may be realized in hardware, software, or a combination thereof.

FIG. 4A depicts a portion of an image array according to an alternate embodiment of the present invention (not drawn to represent actual proportions of element size). Exemplary array portion 400 is shown to include pixel cells from rows 871 to 879 and from columns 1301 to 1309. In operation, when the amount of data associated with the pixels is determined, pixel control signals are sent to the imager 304 (FIG. 3), which in turn operates to retrieve the pixel information (i.e., collection of pixel data) necessary to generate a view as defined by a remote participant.

According to another embodiment of the present, the imaging device operates to provide a one-to-one pixel mapping from the image captured to the image displayed. More specifically, a graphical display is used to form a displayed image where the number of display pixels forming the display image is equivalent to the number of captured pixels digitized as pixel data, where each pixel data value is formed from a corresponding pixel cell. Consequently, the displayed image has the same degree of resolution as the image captured at the optical sensor.

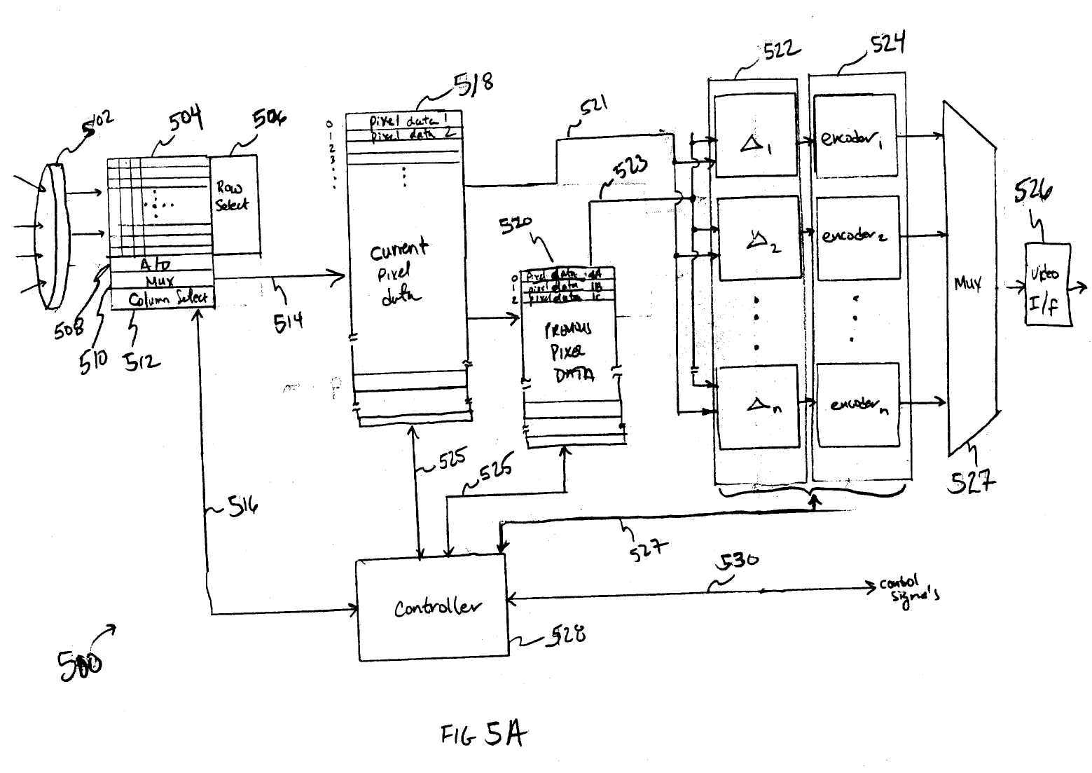

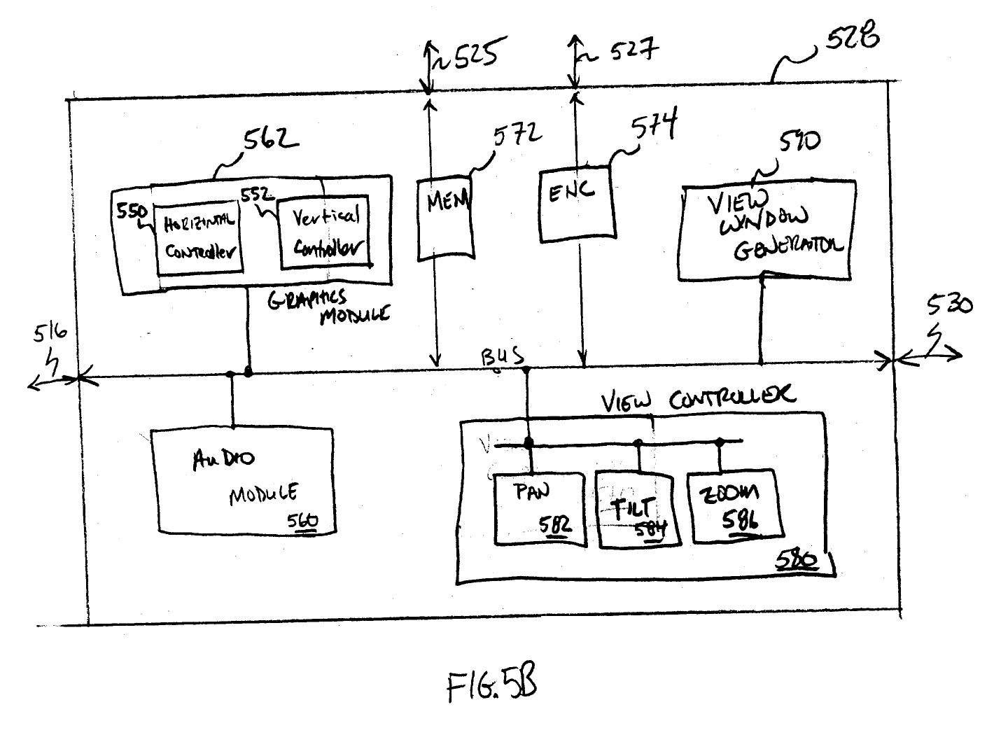

In yet another embodiment, the imaging device operates to adapt the captured image to an appropriate video format for optimum display of the one or more views at the remote participants' computer display. In particular, one or more pixels captured at the imager 304 or 504 (FIG. 5A) are grouped together to form a display pixel. A display pixel as described herein is the smallest addressable unit on a display available according to the capabilities of, for example, a television monitor or a computer display. For example, in a full view at maximum zoom-out, not all pixels need be used to generate the corresponding view. That is, pixel data generated from pixel cells 871-878 and 1301-1308 can be converted to a display pixel 402 in a particular view that comprises a block or a grouping of pixels for presentation on a graphical display, such as a television. A typical television monitor may only have a resolution or a maximum amount of picture detail of 480 dots (i.e., pixels) high×440 dots wide. Since a 480×440resolution television monitor cannot map each pixel from an imager capable of resolving 2008 by 1094 pixels, known pixel interpolation techniques can be applied to ensure that the displayed image accurately and reliably portrays that of the image defined by the remote participants.

A display pixel 402 can be represented, for example, by the average color or the average luminance and/or chrominance of the total number of the related pixels. Other techniques to determine a display pixel from a super-set of smaller pixels are within the scope of this invention. As another example, in a normal view (i.e., no zoom), a number of pixels 408 (i.e., shown with an “X”) can be used rather than the display pixel 402 to obtain both a sharper and a zoomed-in second view for use by the remote participant. In a further example, a narrow view at maximum zoom-in can include each of the pixels associated with pixel cells 871-879 and 1301-1308 for a defined area to present as a view.

The present invention therefore provides techniques to receive view window boundaries and to provide an appropriate number of pixels within the defined area set by the boundaries. Moreover, the present invention provides for pan movements of a view by shifting (i.e., translating) pixels over by a defined number of pixel cells 450 to the left or right. Tilt movements of a view are accomplished, for example, by shifting pixels up or down by a defined number of pixel cells 460. Hence, the present invention need not rely on electromechanical devices to effectuate pan, tilt, zoom, and like functionalities.

FIG. 4B illustrates a display pixel 480, which is formed from pixel data generated from the pixel cells associated with the display pixel 480. The display pixel 480 is shown before a pan operation is initiated. The display pixel 480 is then translated to a position represented by a panned display pixel 482. Thus, after the panning operation is complete, the panned pixel 482 uses pixel cell data generated from pixel cells 483 rather than pixel cells 481. Similarly, FIG. 4C illustrates a display pixel 484 manipulated to form a tilted pixel 486 as a result of a tilt operation. FIG. 4D illustrates a display pixel 492 in relation to the number of pixel cells used to generate the display pixel 492 before a zoom-in operation is performed. After the zoom-in operation is complete, a zoom-in display pixel 490 is shown to relate to fewer pixel cells than the display pixel 492. In one embodiment, the same pixel data values for a specific frame or period of time generate the display pixel 492 and the zoom-in display pixel 490, where the pixel values originate from associated pixel cells.

FIG. 5A shows another embodiment of an exemplary image system 500. At least two memory circuits 518 and 520 are employed to store image data relating to image frames at time t-1 and t. The stored data represents the characteristics of an image as determined by each pixel. For example, if an imager 504 captures the color “red” with pixel at row 590 and column 899, the color red is stored as a binary number at a specific memory location. In some embodiments, data representing a pixel includes chrominance and luminance information.

The image system 500 includes an optical input 502 for providing an optically focused image to the imager 504 comprising an array of pixel cells. In one embodiment, the imager 504 of the image system 500 includes a row select 506 circuit, a column selector 512 circuit to select a charge from one or more specific photodiodes of the pixel cells of the imager 504. Other additional known circuitry for digitizing an image using the imager 504 can also include an analog-to-digital converter 508 circuit and a multiplexer 510 circuit.

A controller 528 of the image system 500 operates to control the generation of one or more views of a scene captured at a local endpoint during a video conference. The controller 528 at least manages the capture of digitized images as pixel data, processes the pixel data, forms one or more displays associated with the digitized image, and transmits the displays as requested to local and remote participants.

In operation, the controller 528 communicates with the imager 504 for capturing digitized representations of an image of the scene via image control signals 516. In one embodiment, the imager 504 provides pixel data values 514 representing the captured image to memory circuits 518 and 520.

The controller 528, via memory control signals 525, also operates to control the amount of pixel data used in displaying one or more views (e.g., to one or more participants), the timing of data processing between previous pixel data in memory circuit 520, and. the current pixel data in memory circuit 518, as well as other memory-related functions.

The controller 528 also controls sending current pixel data 521 and previous pixel data 523 to both a data differentiator 522 and an encoder 524, as described below. Moreover, the controller 528 controls the encoding and transmitting of the display data to remote participants via encoding control signals 527.

FIG. 5B illustrates the controller 528 in accordance with an exemplary embodiment of the present invention. The controller 528 comprises a graphics module 562, a memory controller (“MEM”) 572, an encoder controller (′ENC”) 574, a view widow generator 590, a view controller 580, and an optional audio module 560, all of which communicate via one or more buses to elements within and without the controller 528. Structurally, the controller 528 may comprise either hardware, or software, or both. In alternate embodiments, more or less elements may be encompassed in the controller 528, and other elements may be utilized.

The graphics module 562 controls the rows and the columns of the imager 504 (FIG. 5A). Specifically, a horizontal controller 550 and a vertical controller 552 operate to select one or more columns and one or more rows, respectively, of the array of the imager 505. Thus, the graphics module 562 controls the retrieval of all or only some of the pixel information (i.e., collection of pixel data) necessary to generate at least one view as defined by a remote participant.

A view controller 580, which is responsive to requests via control signals 530, operates to manipulate one or more views presented to a remote participant. The view controller 580 includes a pan module 582, a tilt module 584, and a zoom module 586. The pan module 582 determines the direction (i.e., right or left) and the amount of pan requested, and then selects the pixel data necessary to provide an updated display after the pan operation is complete. The tilt module 584 performs a similar function, but translates a view in a vertical manner. The zoom module 586 determines whether to zoom-in or zoom-out, and the amount thereof, and then calculates the amount of pixel data required for display. Thereafter, the zoom module calculates how best to construct each display pixel using pixel data from corresponding pixel cells.

The memory controller 572 selects the pixel data in memory circuits 518 and 520 that is required for generating a view. The controller 528 manages encoding of views, if desired, the number and characteristics of display pixels, and transmitting encoded data to remote participants. The controller 528 communicates with the encoder 524 (FIG. 5A) for performing picture data encoding.

The view window generator 590 determines a view's boundaries, as defined by a remote participant via control signals 530. The view's boundaries are used to select which pixel data (and pixel cells) are required to effectuate panning, tilting, and zooming operations. Further, the view window generator includes a reference point on a display and a window size to enable a remote participant to modify a view displayed during a video conference.

The vertical controller 552 and the horizontal controller 550, in one embodiment of the present invention, are configured to retrieve only the pixel data from the array necessary to generate a specific view. If more than one view is required, then vertical controller 552 and the horizontal controller 550 operate to retrieve the sets of pixel data related to each requested view at optimized time intervals. For example, if a remote participant requests three views, then the vertical controller 552 and the horizontal controller 550 function to retrieve sets of pixel data in sequence, such as for a first view, then for a second view, and lastly for a third view. Thereafter, the next set of pixel data retrieved can relate to any of the three views based upon how best to efficiently and effectively provide imaging data for remote viewing. One having ordinary skill in the art should appreciate that other timing and controlling configurations are possible to retrieve pixel data from the array and thus are within the scope of the present invention.

Referring back to FIG. 5A, the data differentiator 522 determines whether color data stored at a particular memory location (e.g., related to specific pixels, such as define by row and column) changes over time interval At. The data differentiator 522 may perform motion matching as known in the art of data compression. In one embodiment, only changed information will be transmitted. An encoder 524 will encode the data representing changes in the image (i.e., due to motion or to changes in the require view window) for efficient data transmission. In one embodiment, either one of the data differentiator 522 or the encoder 524, or both, operate according to MPEG standards or other video compression standards known in the art, such as proposed ITU H.264. In another embodiment, each of the data differentiator 522 and the encoder 524 is designed to process multiple views from a single set of frame data. A multiplexer (“MUX”) 527 multiplexes one or more subsets of image data to a video interface 526 for communication to remote participants where each subset of image data represents the portion of the image defined by a view window (as described below). In another embodiment, the MUX 527 operates to combine the subsets of image data for each view to generate a mosaiced picture for display at a remote location.

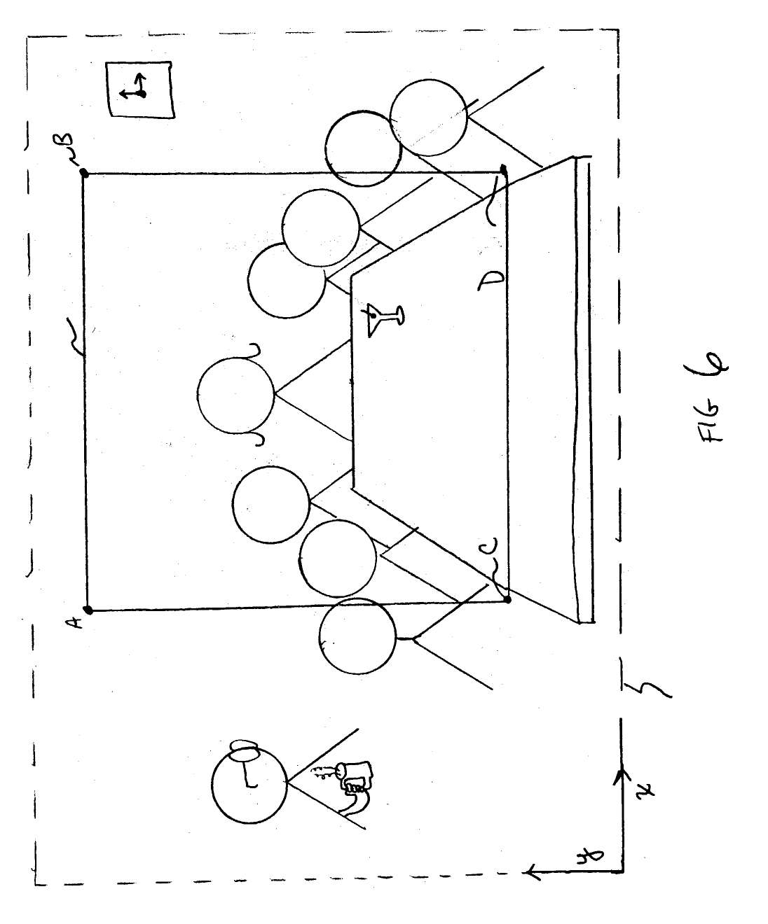

FIG. 6 shows an exemplary normal view (i.e., no zoom) of a scene, where a view window is defined by boundary ABDC. Although the imager receives optical light representing the entire scene, the controller uses only the pixels defined within the view window and at a location in relation to, for example, the lower left corner. That is, the view window with area defined by the zoom function is defined in two-dimension space with point C as the reference point and includes pixel rows up through point A (each pixel row need not be used).

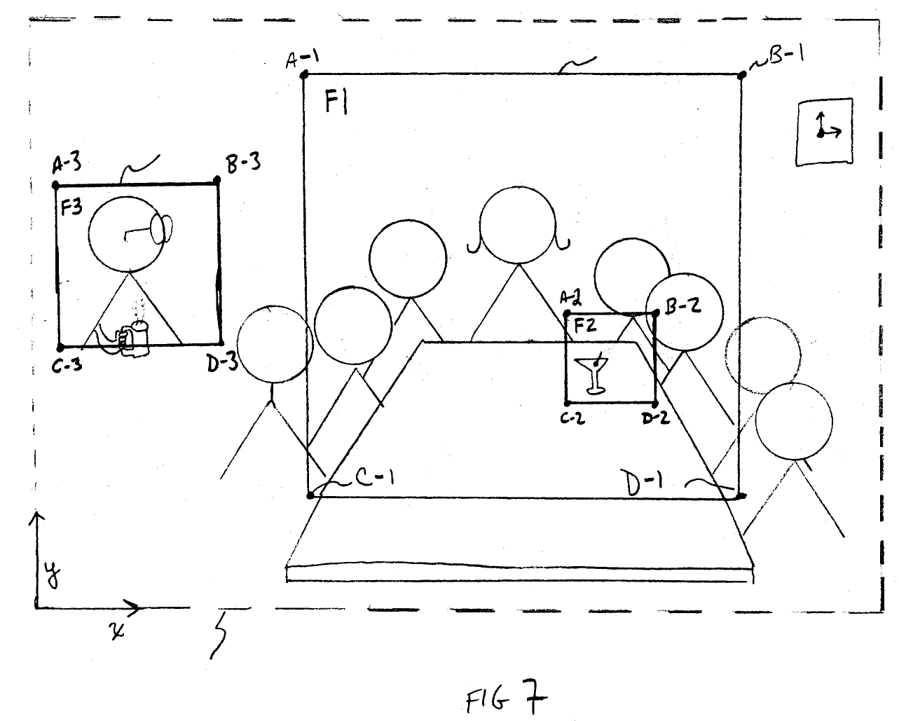

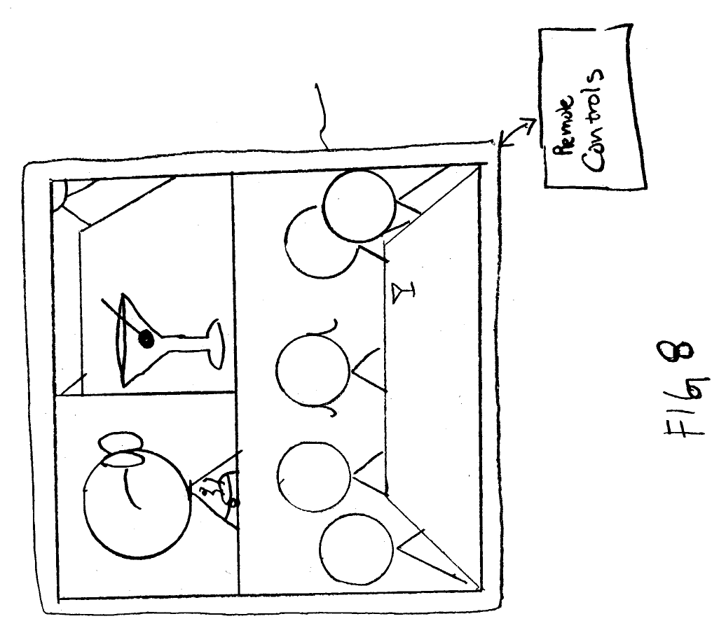

FIG. 7 shows three exemplary view windows F1, F2, and F3 where each view window is at a different level of zoom and uses different pixel locations associated with captured image data for defining the corresponding view. In one embodiment, each view window is based on the same image data projected onto the image array. For example, view windows F1, F2, and F3 include the necessary information to generate three corresponding views as shown in FIG. 8.

FIG. 8 illustrates an example of how each view is displayed at the remote participants' display device based upon corresponding view windows. In another example, views can be presented or displayed to the remote participants as picture-in-picture rather than displayed in a “tiled” fashion as shown in FIG. 8.

Although the present invention has been discussed with respect to specific embodiments, one of ordinary skill in the art will realize that these embodiments are merely illustrative, and not restrictive, of the invention. For example, although the above description describes an exemplary camera used in video conferences, it should be understood that the present invention relates to video devices in general and need not be restricted to use in videoconferences. The scope of the invention is to be determined solely by the appended claims.

what is claimed is:

1. A method for generating a view of a scene at a local endpoint during a video conference, the method comprising:
capturing a digitized representation of an image of the scene by generating a set of pixels data values where each of the pixels data values is associated with a pixel cell of an image sensor;
associating a display pixel of the view with a subset of the pixel data values;
selecting a portion of the image as the view, the portion associated with a number of the pixel cells; and
translating the portion of the image by one or more pixels if a translation control signal is received.

2. The method of claim 1, further comprising:
increasing the number of the pixel cells in the portion if a zoom-out control signal is received; and
decreasing the number of the pixel cells in the portion if a zoom-in control signal is received.

3. The method of claim 1, further comprising generating a next view wherein the number of display pixels forming the next view is substantially equal to a maximum number of pixel cells.

4. The method of claim 1, wherein a maximum number of pixel cells is a number of image sensor pixel cells of the image sensor.

5. The method of claim 1, wherein the image sensor further comprises an array of CMOS pixel cells.

6. The method of claim 1, further comprising generating another view by using the digitized representation of the image, where generating the another view includes:
selecting another portion of the image as the view, the another portion associated with another number of the pixel cells;
translating the another portion of the image by one or more pixels if another translation control signal is received;
increasing the another number of the pixel cells in the another portion if another zoom-out control signal is received; and
decreasing the another number of the pixel cells in the another portion if another zoom-in control signal is received.

7. The method of claim 1, further comprising transmitting the view to a remote endpoint.

8. The method of claim 6, further comprising mosaicing the view and the another view into a display view for transmission to and display at a remote endpoint.

9. The method of claim 1, wherein translating the portion further comprises translating the portion up if a tilt-up control signal is received.

10. The method of claim 1, wherein translating the portion further comprises translating the portion down if a tilt-down control signal is received.

11. The method of claim 1, wherein translating the portion further comprises translating the portion to the right if a pan-right control signal is received.

12. The method of claim 1, wherein translating the portion further comprises translating the portion to the left if a pan-left control signal is received.

13. The method of claim 1, wherein translating the portion is performed substantially instantaneously.

14. The method of claim 1, wherein translating occurs via a non-mechanical means.

15. The method of claim 2, wherein increasing the number of the pixel cells further comprises increasing a number of pixel cells in a subset that contributes to formation of the display pixel.

16. The method of claim 15, wherein a duration of the formation of the display pixel is substantially instantaneously.

17. The method of claim 15, wherein the formation of the display pixel occurs via a non-mechanical means.

18. The method of claim 1, wherein the display pixel is formed by averaging chrominance values and averaging luminance values for the number of pixel cells in the subset.

19. The method of claim 2, wherein decreasing the number of the pixel cells further comprises decreasing a number of pixel cell contributing to formation of the display pixel.

20. A method for providing panning, tilting, and zoom functions at a local endpoint for manipulating a plurality of views from a scene during video conference, the method comprising:
capturing an image using an image sensor, the image sensor including an array of pixel cells;
defining each of the plurality of views by a view window, the view window identifying a plurality of display pixels for displaying a portion of the scene, where each of the display pixels is determined from pixel data generated by a subset of the array of pixel cells;
shifting at least one of the plurality of views by one or more columns of the array of pixels if a pan control signal is received;
shifting at least one of the plurality of views by one or more rows of the array of pixels if a tilt control signal is received; and
changing a number of the pixel cells constituting the subset of the array of pixel cells if a zoom control signal is received.

21. The method of claim 20, wherein changing the number of the one or more pixel cells comprises increasing the number of pixel cells that determine the at least one of the display pixels if a zoom-out control signal is received.

22. The method of claim 20, wherein changing the number of the one or more pixel cells comprises decreasing the number of pixel cells that determine the at least one of the display pixels if a zoom-in control signal is received.

23. The method of claim 20, wherein the view window is defined by:
establishing a reference point proximate to a reference display pixel, which is associated with at least one pixel cell;
generating a view window boundary including the reference point; and
positioning the view window in relation to the reference point.

24. The method of claim 20, wherein the view window for at least one of the plurality view windows is configurable in response to a user input originating at a remote endpoint.

25. The method of claim 20, wherein the image sensor is a CMOS image sensor.

26. The method of claim 20, wherein each of the plurality of views is determined from pixel data generated by the array of pixel cells during one frame.

27. A video conference endpoint comprising:
an image sensor circuit including an array of pixel cells, the sensor configured to digitize an image of a scene into a plurality of display pixels, where each of the plurality of display pixels is generated from pixel data associated with one or more pixel cells of the array; and
a controller configured to generate at least one requested view of the scene by manipulating the pixel data if a control signal is received.

28. The endpoint of claim 27, wherein the image sensor is a CMOS image sensor.

29. The endpoint of claim 27, further comprising:
a memory circuit configured to store the pixel data; and
an encoder configured to compress the pixel data representing the view.

30. The endpoint of claim 27, wherein the control signal is a pan control signal and the controller is configured to shift the pixel cells by at least one column of the array.

31. The endpoint of claim 27, wherein the control signal is a tilt control signal and the controller is configured to shift the pixel cells by at least one row of the array.

32. The endpoint of claim 27, wherein the control signal is a zoom control signal and the controller is configured to change a number of the array of pixel cells that determine at least one display pixel of the view.

33. A method for providing panning, tilting, and zoom functions at a local endpoint for manipulating a plurality of views from a scene during video conference, the method comprising:
means for capturing an image;
means for defining each of the plurality of views of the image; and
means for manipulating at least one view of the plurality of views by changing a subset of the array of pixel cells constituting at least the one view.

34. The endpoint of claim 33, the means for manipulating the at least one view further comprises:
means for shifting the one view by one or more columns associated with the subset of the array of pixels if a pan control signal is received;
means for shifting the one view by one or more rows associated with the subset of the array of pixels if a tilt control signal is received; and
means for changing a number of the one or more pixel cells that determine a number of display pixels constituting the one view if a zoom control signal is received.
